(19) United States
(12) Patent Application Publication
(10) Pub. No.: US 2018/0352038 A1
(43) Pub. Date: Dec. 6, 2018

(54) ENHANCED NFV SWITCHING

(71) Applicant: Intel Corporation, Santa Clara, CA (US)

(72) Inventors: Krishnamurthy Jambur Sathyanarayana, Limerick (IE); Niall Power, Limerick (IE); Christopher MacNamara, Limerick (IE); Mark D. Gray, Dublin (IE)

(73) Assignee: Intel Corporation, Santa Clara, CA (US)

(21) Appl. No.: 15/607,832

(22) Filed: May 30, 2017

(51) Int. Cl. H04L 29/08; G06F 9/455; G06F 9/50

(52) U.S. Cl. CPC H04L 67/16; G06F 9/45558; G06F 21/44; G06F 2009/45595; G06F 9/50

(57) ABSTRACT

A computing apparatus, including: a hardware platform; and a virtual switch (vSwitch) to operate on the hardware platform, the vSwitch including a virtual ingress interface, an inline virtual egress interface to communicatively couple to an inline data path, a diverted virtual egress interface to communicatively couple to a diverted data path, a diversion logic block, and logic to: communicatively couple to a local virtual machine (VM) via the diverted data path, the VM to provide an edge computing function; communicatively couple to a downstream data center via the inline data path; receive an incoming packet via the virtual ingress interface; determine that the incoming packet belongs to a class of packets for diversion processing; provide the incoming packet to the diversion logic block, wherein the diversion logic block is to determine that the packet is an edge computing flow to be diverted to the edge computing function via the diverted data path; and direct the incoming packet to the local VM via the diverted virtual egress interface.

### FIELD OF THE SPECIFICATION

This disclosure relates in general to the field of cloud computing, and more particularly, though not exclusively to, a system and method for enhanced network function virtualization (NFV) switching.

### BACKGROUND

Contemporary computing practice has moved away from hardware-specific computing and toward “the network is the device.” A contemporary network may include a data center hosting a large number of generic hardware server devices, contained in a server rack for example, and controlled by a hypervisor. Each hardware device may run one or more instances of a virtual device, such as a workload server or virtual desktop.

### BRIEF DESCRIPTION OF THE DRAWINGS

The present disclosure is best understood from the following detailed description when read with the accompanying figures. It is emphasized that, in accordance with the standard practice in the industry, 5various features are not necessarily drawn to scale, and are used for illustration purposes only. Where a scale is shown, explicitly or implicitly, it provides only one illustrative example. In other embodiments, the dimensions of the various features may be arbitrarily increased or reduced for clarity of discussion.

FIG. 1 is a network-level diagram of a cloud service provider (CSP) according to one or more examples of the present specification.

FIG. 2 is a block diagram of a data center according to one or more examples of the present specification.

FIG. 3 is a block diagram of a network function virtualization (NFV) architecture according to one or more examples of the present specification.

FIG. 4 is a block diagram of a wireless network according to one or more examples of the present specification.

FIG. 5 is a block diagram of selected elements of a virtual network infrastructure according to one or more examples of the present specification.

FIG. 6 is a block diagram of a virtual network infrastructure according to one or more examples of the present specification.

FIG. 7 illustrates an instance of streamlining wherein a vSwitch includes MEC services logic according to one or more examples of the present specification.

FIG. 8 is a block diagram of a vSwitch according to one or more examples of the present specification.

FIG. 9 is a further diagram of a vSwitch according to one or more examples of the present specification.

FIG. 10 is a flowchart of a method of performing enhanced NFV switching according to one or more examples of the present specification.

### EMBODIMENTS OF THE DISCLOSURE

The following disclosure provides many different embodiments, or examples, for implementing different features of the present disclosure. Specific examples of components and arrangements are described below to simplify the present disclosure. These are, of course, merely examples and are not intended to be limiting. Further, the present disclosure may repeat reference numerals and/or letters in the various examples. This repetition is for the purpose of simplicity and clarity and does not in itself dictate a relationship between the various embodiments and/or configurations discussed. Different embodiments may have different advantages, and no particular advantage is necessarily required of any embodiment.

As both workload functions and network functions become increasingly virtualized in data centers and other data services, virtual switches (vSwitches) see an increasing share of traffic. A vSwitch is a virtualized network switch that provides packet switching between virtual machines (VMs), such as VMs located on a single hardware platform.

In some cases, a vSwitch may be tasked with determining whether a packet should be switched to the normal “inline” path, or should be “diverted” to a diverted path. Taking as an example multi-access edge computing (MEC), a workload function that is normally performed further downstream may be cloned and provided closer to the edge of the network (both logically in number of hops and physically in distance from the edge of the network) to reduce latency for certain classes of traffic.

MEC provides edge of the network application deployment for heterogeneous networks like LTE, Wi-Fi, and NarrowBand Internet of things (NB-IoT), and similar. It provides a platform to deploy 4G and 5G services with high bandwidth and low latency. By way of example, MEC may be embodied as a virtual machine or function listening on several interfaces and a global network node to service the delivery mechanism. MEC switching listens for messages and may be deployed as a standalone function, although MEC switching shares some similarities with traditional network switching.

Providing some additional intelligence in the vSwitch can add MEC switching functionality to the vSwitch to provide better performance and a smaller network footprint.

For example, in a 4G LTE or 5G wireless network, some classes of users may pay for high-speed data that can be used to consume bandwidth-intensive applications such as a video streaming service. Normally, the workload function of the video streaming service may be provided in a large data center inside or on the other side of the evolved packet core (EPC) network. Thus, when a user accesses the video streaming service, the user's packets are routed via the wireless tower to an eNodeB, from the eNodeB to the EPC, and from the EPC to a workload server in a data center.

Both the number of hops involved in this transaction and the physical distance traversed by the packets may introduce latency into the transaction. While the latency may be acceptable for ordinary use cases, some premium subscribers may be guaranteed higher bandwidth and/or lower-latency access to the video streaming service.

Thus, the workload function of the video streaming service may be cloned and provided as an edge service in a virtual machine much closer to the end user, such as in a blade server co-located with or near the eNodeB.

In an embodiment of MEC, an incoming packet may first hit the virtual LAN (vLAN), which inspects the packet and determines whether the packet belongs to a class of flows or packets that are candidates for MEC. Note that this is a gateway function, and in some cases may be relatively less processor intensive than the actual MEC processing, as the purpose is to determine whether the packet needs an MEC decision. Also note that in some cases, the “class” of packets that are candidates for MEC (or other “diversion” processing) may include all packets.

If the packet is determined to be in a class of network traffic that is potentially subject to MEC (or other diversion) processing, the packet may be switched to an MEC platform services VM. The MEC platform services VM inspects the packet to determine whether the packet should be diverted to a local MEC application, or should be sent via the normal inline path to a downstream workload service. As used throughout this specification, the term “divert” should be understood to include any special routing or switching of a packet to a destination other than one that would be reached via the normal flow of traffic. In particular, a diversion may include switching a packet to a virtual network function (VNF), edge service, or workload server other than the normal path for its (for example) destination IP address. By way of example, a packet may have a destination address of 10.0.0.4, which is a virtual IP address (VIP) that ordinarily routes to a load balancer that load balances the traffic to a plurality of workload servers providing the network function in a data center. However, in the case of a diversion, a function such as an MEC platform services VM may determine that the packet should be diverted, such as to a local workload server providing the same function with a lower latency. Further as used throughout this specification, a packet is directed to an “inline” path if it is not diverted. In other words, a packet with the destination IP address of 10.0.0.4 is switched to the downstream data center, where it hits the load balancer that services that virtual IP address, and is handled by a workload server in the ordinary workload server pool. Note that in many cases, the “inline” path may include some number of network functions in a “service chain” that a packet is to traverse before hitting its ultimately destination IP address. In the case where the service chain is part of the normal packet flow, passing the packet through the service chain before forwarding it to the final destination IP address is not considered “diverting” the packet for purposes of this specification and the appended claims.

In the case that a packet is diverted, the packet may “ping-pong” between various VMs in the virtualized environment before reaching its ultimate destination (e.g., WAN→vSwitch→MEC Services VM→vSwitch→MEC Workload→vSwitch→WAN). While the latency in this case may be less than the latency for sending the packet via an inline path, it may still be desirable to further reduce the latency where possible. One method of reducing the latency is to provide, for example, the MEC platform services function not in a separate VM, but within the logic of the vSwitch itself. For example, a plug-in architecture or framework may be provided, so that a generic vSwitch includes a plug-in API that enables it to interoperate with an embedded VNF function natively. In this case, the packet hits the vSwitch, and rather than switching the packet to an MEC platform services VM, the vSwitch identifies the packet as belonging to a class for MEC processing, and handles the MEC processing via its plug-in API. A “diversion logic plug-in” (i.e., a plugin that provides the logic for making diversion decisions for the packet) may then interface with the plug-in API to determine whether the packet should be diverted or should be forwarded via the inline path.

The diversion logic plug-in may itself be provided in software, firmware, or in hardware (as in an accelerator). For example, the plug-in could be provided purely in software on the vSwitch and interface with the rest of the vSwitch via the plug-in API. In another example, the plug-in API provides a hardware driver interface to a hardware accelerator that provides the diversion logic plug-in. This hardware could be, for example, an ASIC or an FPGA. Advantageously, a hardware diversion logic plug-in may be able to process the packet very quickly, thus further reducing latency.

Thus, to provide an illustrative example, the packet may hit the vSwitch, and the vSwitch may inspect the packet to determine whether it is a candidate for diversion. If the packet is a candidate for diversion, then the packet may be provided via the plug-in API to diversion logic implemented in an FPGA or ASIC, which performs a more detailed inspection the packet to determine whether this packet should be diverted. The more detailed inspection could include, for example, inspecting additional attributes of the packet such as a subscriber ID associated with the source node. This subscriber ID may be matched against a list of subscribers who have paid for higher bandwidth and or lower latency, and in the case of a match, the packet may be directly switched from the vSwitch to a collocated MEC workload VM, such as on the eNodeB.

In the prior example, the diversion logic was described in terms of a plug-in that interfaces with the vSwitch via a plug-in API. However, it should also be noted that other embodiments are possible. In another example, the diversion logic plug-in is tightly integrated with the vSwitch logic, and may be provided in either hardware or software. Thus, a vSwitch may be programmed which natively supports an NFV diversion function such as MEC without the need for a plug-in. This embodiment may provide higher speed and efficiency at the cost of some flexibility. Thus the selection of whether to use a plug-in architecture with a modular diversion logic plug-in versus a tightly coupled or tightly integrated diversion logic plug-in is an exercise of skill in the art.

Advantageously, the system described herein makes the V switch more flexible and extensible by providing native or plug-in support for a diversion function, such as an NVF function. Certain embodiments may also have a discovery function to detect the availability of accelerators, such as hardware or software accelerators that may be offloaded. Once the available accelerators are detected, the vSwitch may load the appropriate plug-in drivers for those accelerators and thus provide an accelerated function.

It should also be noted that MEC is disclosed herein as a nonlimiting example of a diversion function that may be provided by a vSwitch. However, many other functions are possible. By way of nonlimiting example, these could include software cryptography (encryption/decryption) wireless algorithms, deep packet inspection (DPI), and IP security (IPsec) or big data functions such as packet counting and statistics. Note that the NFV functions described need not be provided on the switch itself, but rather the switch may be provided with diversion logic to determine whether packets should be diverted to a particular function, or should be handled via their ordinary inline paths. The functions themselves may be provided in VMs, in FPGAs, next generation NICs, IP blocks, accelerators such as Intel® Quick Assist Technology™, smart NICs, or any other suitable function. Also note that the diversion function may divert based on factors other than inherent or internal properties of the packet itself. For example, the diversion function may divert based on the availability or the current load on an available accelerator, the current load on a CPU, volume of network traffic, or any other factor that provides a useful marker for packet diversion.

In some embodiments, hardware changes to realize the diversion architecture disclosed herein may be an optimized implementation of the interface between the vSwitch and one or more hardware modules, such as a data plane development kit (DPDK) interface in hardware. This allows vSwitch to be seamlessly integrated with hardware plug-in modules. If the plug-in is implemented in hardware, then very low latency and very high bandwidth may be achieved with this architecture. In yet another embodiment, vSwitch itself may be implemented in hardware. Thus, the use of a plug-in API may extend the functionality and flexibility of a hardware vSwitch by allowing it to provide pluggable diversion functions that are not natively supported in vSwitch hardware.

The system proposed herein combines a vSwitch and the MEC services software into a single software switching component with advantageous and optional hardware offload capability. As described above, in existing systems, these may exist as separate software processes on a system such as an NFV platform for EPC, or on a base station. These elements may be very compute intensive with high memory usage, so they may be deployed as a cluster of nodes, which equates to a number of VMs in a virtualized environment such as NFV.

Advantageously, this eliminates a potential bottleneck, as all traffic or all traffic in a certain class may have to pass through a single VM hosting the MEC platform services. This could include IP identification, routing, encapsulation, and/or decapsulation. However, by incorporating the MEC platform service traffic offload function into the vSwitch, substantial savings may be realized in terms of performance by avoiding the overhead of routing packets through a separate MEC service and then switching them back to the vSwitch so that they can be sent to a separate VM on the system. Operational expenses and operational costs may thus be reduced and hardware may be freed up for other processes. Further advantageously, the plug-in architecture described herein increases the capability and flexibility of a generic vSwitch. For example, as discussed herein, MEC may be modularly replaced with any other NFV or diversion function, without modification of the vSwitch itself.

A system and method for enhanced NFV switching will now be described with more particular reference to the attached FIGURES. It should be noted that throughout the FIGURES, certain reference numerals may be repeated to indicate that a particular device or block is wholly or substantially consistent across the FIGURES. This is not, however, intended to imply any particular relationship between the various embodiments disclosed. In certain examples, a genus of elements may be referred to by a particular reference numeral (“widget 10”), while individual species or examples of the genus may be referred to by a hyphenated numeral (“first specific widget 10-1” and “second specific widget 10-2”).

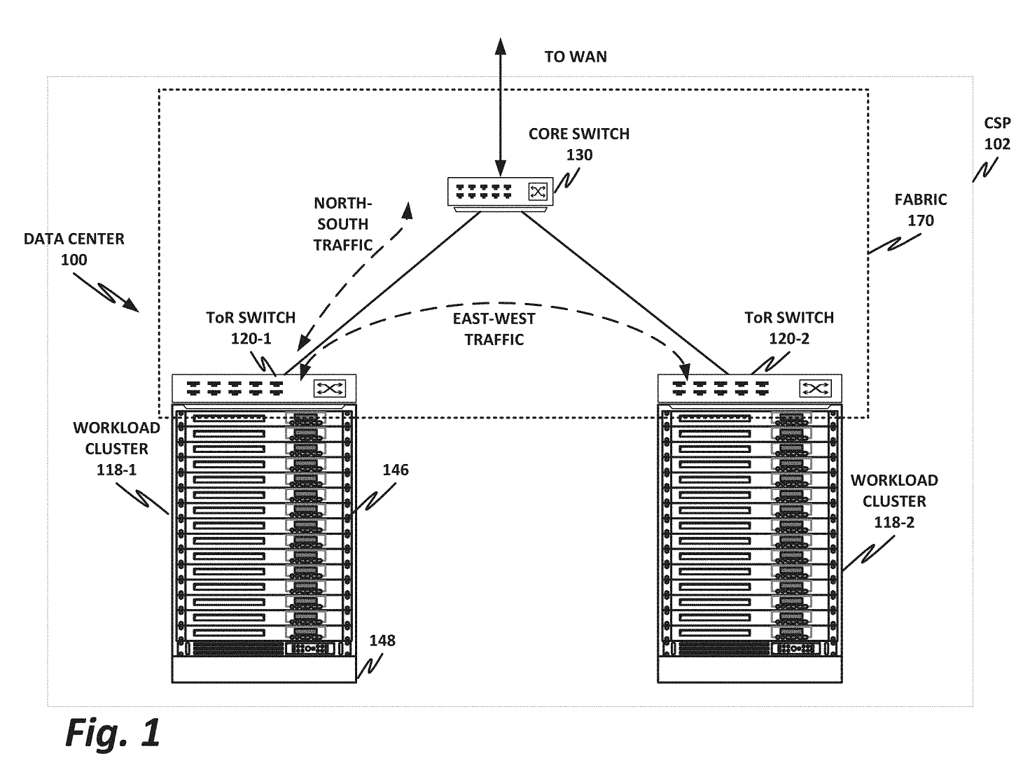

FIG. 1 is a network-level diagram of a network 100 of a cloud service provider (CSP) 102, according to one or more examples of the present specification. CSP 102 may be, by way of nonlimiting example, a traditional enterprise data center, an enterprise “private cloud,” or a “public cloud,” providing services such as infrastructure as a service (IaaS), platform as a service (PaaS), or software as a service (SaaS).

In an embodiment, CSP 102 may be configured and operated to provide services including both inline and diverted services as described herein.

CSP 102 may provision some number of workload clusters 118, which may be clusters of individual servers, blade servers, rackmount servers, or any other suitable server topology. In this illustrative example, two workload clusters, 118-1 and 118-2 are shown, each providing rackmount servers 146 in a chassis 148.

Each server 146 may host a standalone operating system and provide a server function, or servers may be virtualized, in which case they may be under the control of a virtual machine manager (VMM), hypervisor, and/or orchestrator, and may host one or more virtual machines, virtual servers, or virtual appliances. These server racks may be collocated in a single data center, or may be located in different geographic data centers. Depending on the contractual agreements, some servers 146 may be specifically dedicated to certain enterprise clients or tenants, while others may be shared.

The various devices in a data center may be connected to each other via a switching fabric 170, which may include one or more high speed routing and/or switching devices. Switching fabric 170 may provide both “north-south” traffic (e.g., traffic to and from the wide area network (WAN), such as the internet), and “east-west” traffic (e.g., traffic across the data center). Historically, north-south traffic accounted for the bulk of network traffic, but as web services become more complex and distributed, the volume of east-west traffic has risen. In many data centers, east-west traffic now accounts for the majority of traffic.

Furthermore, as the capability of each server 146 increases, traffic volume may further increase. For example, each server 146 may provide multiple processor slots, with each slot accommodating a processor having four to eight cores, along with sufficient memory for the cores. Thus, each server may host a number of VMs, each generating its own traffic.

To accommodate the large volume of a traffic in a data center, a highly capable switching fabric 170 may be provided. Switching fabric 170 is illustrated in this example as a “flat” network, wherein each server 146 may have a direct connection to a top-of-rack (ToR) switch 120 (e.g., a “star” configuration), and each ToR switch 120 may couple to a core switch 130. This two-tier flat network architecture is shown only as an illustrative example. In other examples, other architectures may be used, such as three-tier star or leaf-spine (also called “fat tree” topologies) based on the “Clos” architecture, hub-and-spoke topologies, mesh topologies, ring topologies, or 3-D mesh topologies, by way of nonlimiting example.

The fabric itself may be provided by any suitable interconnect. For example, each server 146 may include a fabric interface, such as an Intel® Host Fabric Interface™ (HFI), a network interface card (NIC), or other host interface. The host interface itself may couple to one or more processors via an interconnect or bus, such as PCI, PCIe, or similar, and in some cases, this interconnect bus may be considered to be part of fabric 170.

The interconnect technology may be provided by a single interconnect or a hybrid interconnect, such where PCIe provides on-chip communication, 1 Gb or 10 Gb copper Ethernet provides relatively short connections to a ToR switch 120, and optical cabling provides relatively longer connections to core switch 130. Interconnect technologies include, by way of nonlimiting example, Intel® OmniPath™, TrueScale™, Ultra Path Interconnect (UPI) (formerly called QPI or KTI), STL, FibreChannel, Ethernet, FibreChannel over Ethernet (FCoE), InfiniBand, PCI, PCIe, or fiber optics, to name just a few. Some of these will be more suitable for certain deployments or functions than others, and selecting an appropriate fabric for the instant application is an exercise of ordinary skill.

Note however that while high-end fabrics such as OmniPath™ are provided herein by way of illustration, more generally, fabric 170 may be any suitable interconnect or bus for the particular application. This could, in some cases, include legacy interconnects like local area networks (LANs), token ring networks, synchronous optical networks (SONET), asynchronous transfer mode (ATM) networks, wireless networks such as WiFi and Bluetooth, “plain old telephone system” (POTS) interconnects, or similar. It is also expressly anticipated that in the future, new network technologies will arise to supplement or replace some of those listed here, and any such future network topologies and technologies can be or form a part of fabric 170.

In certain embodiments, fabric 170 may provide communication services on various “layers,” as originally outlined in the OSI seven-layer network model. In contemporary practice, the OSI model is not followed strictly. In general terms, layers 1 and 2 are often called the “Ethernet” layer (though in large data centers, Ethernet has often been supplanted by newer technologies). Layers 3 and 4 are often referred to as the transmission control protocol/internet protocol (TCP/IP) layer (which may be further subdivided into TCP and IP layers). Layers 5-7 may be referred to as the “application layer.” These layer definitions are disclosed as a useful framework, but are intended to be nonlimiting.

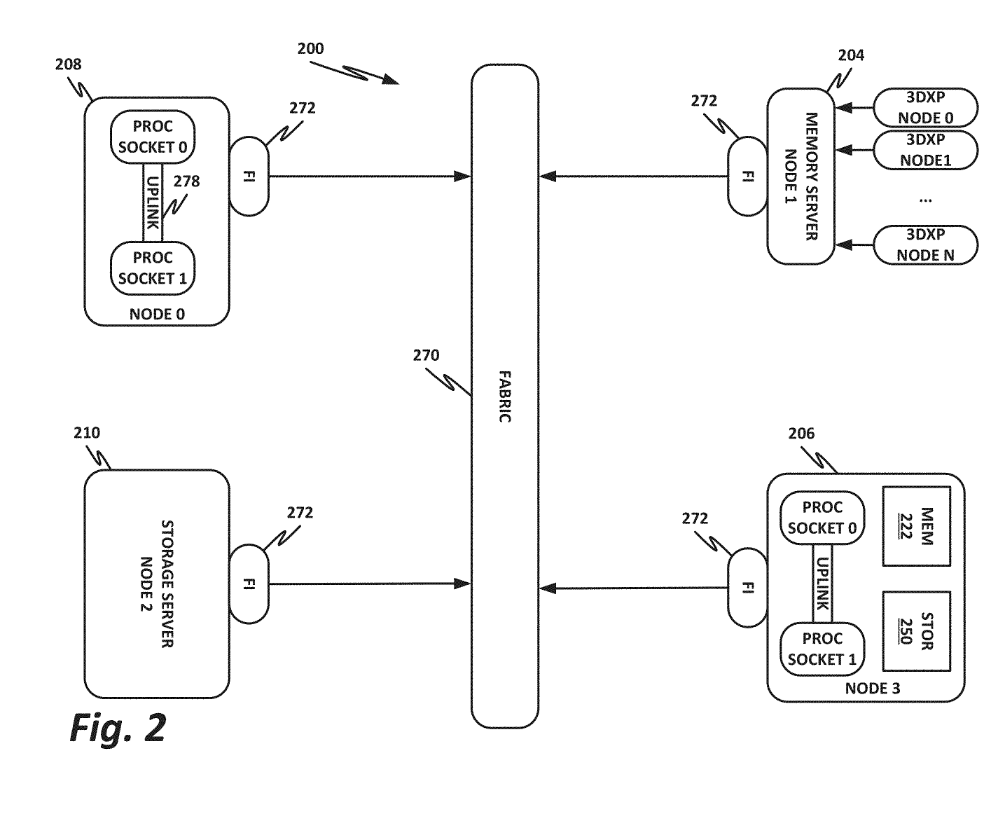

FIG. 2 is a block diagram of a data center 200 according to one or more examples of the present specification. Data center 200 may be, in various embodiments, the same data center as Data Center 100 of FIG. 1, or may be a different data center. Additional views are provided in FIG. 2 to illustrate different aspects of data center 200.

In this example, a fabric 270 is provided to interconnect various aspects of data center 200. Fabric 270 may be the same as fabric 170 of FIG. 1, or may be a different fabric. As above, fabric 270 may be provided by any suitable interconnect technology. In this example, Intel® OmniPath™ is used as an illustrative and nonlimiting example.

As illustrated, data center 200 includes a number of logic elements forming a plurality of nodes. It should be understood that each node may be provided by a physical server, a group of servers, or other hardware. Each server may be running one or more virtual machines as appropriate to its application.

Node 0 208 is a processing node including a processor socket 0 and processor socket 1. The processors may be, for example, Intel® Xeon™ processors with a plurality of cores, such as 4 or 8 cores. Node 0 208 may be configured to provide network or workload functions, such as by hosting a plurality of virtual machines or virtual appliances.

Onboard communication between processor socket 0 and processor socket 1 may be provided by an onboard uplink 278. This may provide a very high speed, short-length interconnect between the two processor sockets, so that virtual machines running on node 0 208 can communicate with one another at very high speeds. To facilitate this communication, a virtual switch (vSwitch) may be provisioned on node 0 208, which may be considered to be part of fabric 270.

Node 0 208 connects to fabric 270 via a fabric interface 272. Fabric interface 272 may be any appropriate fabric interface as described above, and in this particular illustrative example, may be an Intel® Host Fabric Interface™ for connecting to an Intel® OmniPath™ fabric. In some examples, communication with fabric 270 may be tunneled, such as by providing UPI tunneling over OmniPath™.

Because data center 200 may provide many functions in a distributed fashion that in previous generations were provided onboard, a highly capable fabric interface 272 may be provided. Fabric interface 272 may operate at speeds of multiple gigabits per second, and in some cases may be tightly coupled with node 0 208. For example, in some embodiments, the logic for fabric interface 272 is integrated directly with the processors on a system-on-a-chip. This provides very high speed communication between fabric interface 272 and the processor sockets, without the need for intermediary bus devices, which may introduce additional latency into the fabric. However, this is not to imply that embodiments where fabric interface 272 is provided over a traditional bus are to be excluded. Rather, it is expressly anticipated that in some examples, fabric interface 272 may be provided on a bus, such as a PCIe bus, which is a serialized version of PCI that provides higher speeds than traditional PCI. Throughout data center 200, various nodes may provide different types of fabric interfaces 272, such as onboard fabric interfaces and plug-in fabric interfaces. It should also be noted that certain blocks in a system on a chip may be provided as intellectual property (IP) blocks that can be “dropped” into an integrated circuit as a modular unit. Thus, fabric interface 272 may in some cases be derived from such an IP block.

Note that in “the network is the device” fashion, node 0 208 may provide limited or no onboard memory or storage. Rather, node 0 208 may rely primarily on distributed services, such as a memory server and a networked storage server. Onboard, node 0 208 may provide only sufficient memory and storage to bootstrap the device and get it communicating with fabric 270. This kind of distributed architecture is possible because of the very high speeds of contemporary data centers, and may be advantageous because there is no need to over-provision resources for each node. Rather, a large pool of high-speed or specialized memory may be dynamically provisioned between a number of nodes, so that each node has access to a large pool of resources, but those resources do not sit idle when that particular node does not need them.

In this example, a node 1 memory server 204 and a node 2 storage server 210 provide the operational memory and storage capabilities of node 0 208. For example, memory server node 1 204 may provide remote direct memory access (RDMA), whereby node 0 208 may access memory resources on node 1 204 via fabric 270 in a DMA fashion, similar to how it would access its own onboard memory. The memory provided by memory server 204 may be traditional memory, such as double data rate type 3 (DDR3) dynamic random access memory (DRAM), which is volatile, or may be a more exotic type of memory, such as a persistent fast memory (PFM) like Intel® 3D Crosspoint™ (3DXP), which operates at DRAM-like speeds, but is nonvolatile.

Similarly, rather than providing an onboard hard disk for node 0 208, a storage server node 2 210 may be provided. Storage server 210 may provide a networked bunch of disks (NBOD), PFM, redundant array of independent disks (RAID), redundant array of independent nodes (RAIN), network attached storage (NAS), optical storage, tape drives, or other nonvolatile memory solutions.

Thus, in performing its designated function, node 0 208 may access memory from memory server 204 and store results on storage provided by storage server 210. Each of these devices couples to fabric 270 via a fabric interface 272, which provides fast communication that makes these technologies possible.

By way of further illustration, node 3 206 is also depicted. Node 3 206 also includes a fabric interface 272, along with two processor sockets internally connected by an uplink. However, unlike node 0 2808, node 3 206 includes its own onboard memory 222 and storage 250. Thus, node 3 206 may be configured to perform its functions primarily onboard, and may not be required to rely upon memory server 204 and storage server 210. However, in appropriate circumstances, node 3 206 may supplement its own onboard memory 222 and storage 250 with distributed resources similar to node 0 208.

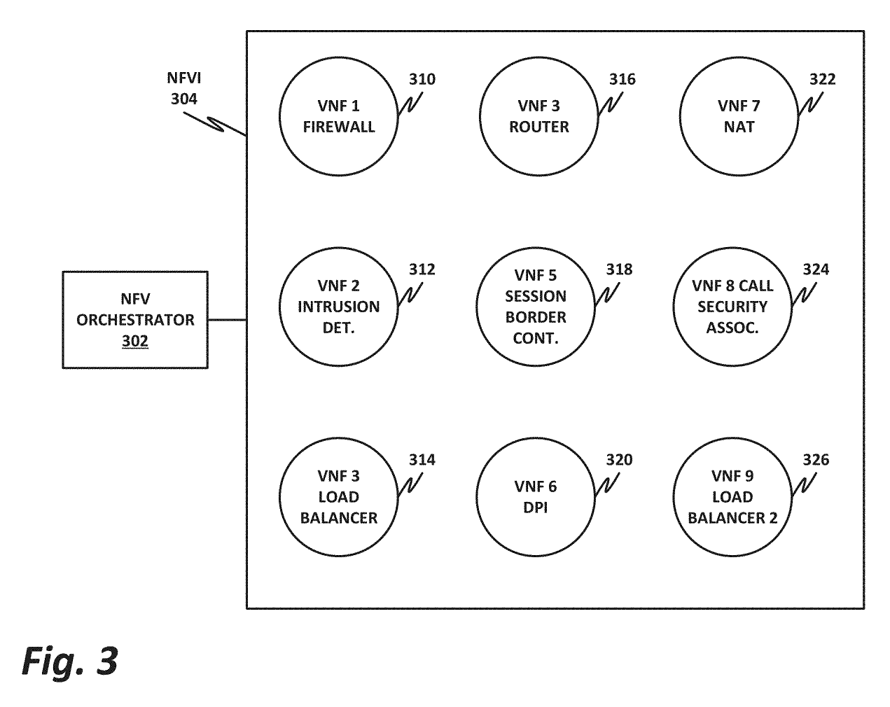

FIG. 3 is a block diagram of a network function virtualization (NFV) architecture according to one or more examples of the present specification. NFV is a second nonlimiting flavor of network virtualization, often treated as an add-on or improvement to SDN, but sometimes treated as a separate entity. NFV was originally envisioned as a method for providing reduced capital expenditure (Capex) and operating expenses (Opex) for telecommunication services. One important feature of NFV is replacing proprietary, special-purpose hardware appliances with virtual appliances running on commercial off-the-shelf (COTS) hardware within a virtualized environment. In addition to Capex and Opex savings, NFV provides a more agile and adaptable network. As network loads change, virtual network functions (VNFs) can be provisioned (“spun up”) or removed (“spun down”) to meet network demands. For example, in times of high load, more load balancer VNFs may be spun up to distribute traffic to more workload servers (which may themselves be virtual machines). In times when more suspicious traffic is experienced, additional firewalls or deep packet inspection (DPI) appliances may be needed.

Because NFV started out as a telecommunications feature, many NFV instances are focused on telecommunications. However, NFV is not limited to telecommunication services. In a broad sense, NFV includes one or more VNFs running within a network function virtualization infrastructure (NFVI). Often, the VNFs are inline service functions that are separate from workload servers or other nodes. These VNFs can be chained together into a service chain, which may be defined by a virtual subnetwork, and which may include a serial string of network services that provide behind-the-scenes work, such as security, logging, billing, and similar.

The illustration of this in FIG. 3 may be considered more functional, compared to more high-level, logical network layouts. Like SDN, NFV is a subset of network virtualization. In other words, certain portions of the network may rely on SDN, while other portions (or the same portions) may rely on NFV.

In the example of FIG. 3, an NFV orchestrator 302 manages a number of the VNFs running on an NFVI 304. NFV requires nontrivial resource management, such as allocating a very large pool of compute resources among appropriate numbers of instances of each VNF, managing connections between VNFs, determining how many instances of each VNF to allocate, and managing memory, storage, and network connections. This may require complex software management, thus the need for NFV orchestrator 302.

Note that NFV orchestrator 302 itself is usually virtualized (rather than a special-purpose hardware appliance). NFV orchestrator 302 may be integrated within an existing SDN system, wherein an operations support system (OSS) manages the SDN. This may interact with cloud resource management systems (e.g., OpenStack) to provide NFV orchestration. An NFVI 304 may include the hardware, software, and other infrastructure to enable VNFs to run. This may include a rack or several racks of blade or slot servers (including, e.g., processors, memory, and storage), one or more data centers, other hardware resources distributed across one or more geographic locations, hardware switches, or network interfaces. An NFVI 304 may also include the software architecture that enables hypervisors to run and be managed by NFV orchestrator 302.Running on NFVI 304 are a number of virtual machines, each of which in this example is a VNF providing a virtual service appliance. These include, as nonlimiting and illustrative examples, VNF 1 310, which is a firewall, VNF 2 312, which is an intrusion detection system, VNF 3 314, which is a load balancer, VNF 4 316, which is a router, VNF 5 318, which is a session border controller, VNF 6 320, which is a deep packet inspection (DPI) service, VNF 7 322, which is a network address translation (NAT) module, VNF 8 324, which provides call security association, and VNF 9326, which is a second load balancer spun up to meet increased demand.

Firewall 310 is a security appliance that monitors and controls the traffic (both incoming and outgoing), based on matching traffic to a list of “firewall rules.” Firewall 310 may be a barrier between a relatively trusted (e.g., internal) network, and a relatively untrusted network (e.g., the Internet). Once traffic has passed inspection by firewall 310, it may be forwarded to other parts of the network.

Intrusion detection 312 monitors the network for malicious activity or policy violations. Incidents may be reported to a security administrator, or collected and analyzed by a security information and event management (SIEM) system. In some cases, intrusion detection 312 may also include antivirus or antimalware scanners.

Load balancers 314 and 326 may farm traffic out to a group of substantially identical workload servers to distribute the work in a fair fashion. In one example, a load balancer provisions a number of traffic “buckets,” and assigns each bucket to a workload server. Incoming traffic is assigned to a bucket based on a factor, such as a hash of the source IP address. Because the hashes are assumed to be fairly evenly distributed, each workload server receives a reasonable amount of traffic.

Router 316 forwards packets between networks or subnetworks. For example, router 316 may include one or more ingress interfaces, and a plurality of egress interfaces, with each egress interface being associated with a resource, subnetwork, virtual private network, or other division. When traffic comes in on an ingress interface, router 316 determines what destination it should go to, and routes the packet to the appropriate egress interface.

Session border controller 318 controls voice over IP (VoIP) signaling, as well as the media streams to set up, conduct, and terminate calls. In this context, “session” refers to a communication event (e.g., a “call”). “Border” refers to a demarcation between two different parts of a network (similar to a firewall).

DPI appliance 320 provides deep packet inspection, including examining not only the header, but also the content of a packet to search for potentially unwanted content (PUC), such as protocol non-compliance, malware, viruses, spam, or intrusions.

NAT module 322 provides network address translation services to remap one IP address space into another (e.g., mapping addresses within a private subnetwork onto the larger internet).

Call security association 324 creates a security association for a call or other session (see session border controller 318 above). Maintaining this security association may be critical, as the call may be dropped if the security association is broken.

The illustration of FIG. 3 shows that a number of VNFs have been provisioned and exist within NFVI 304. This figure does not necessarily illustrate any relationship between the VNFs and the larger network.

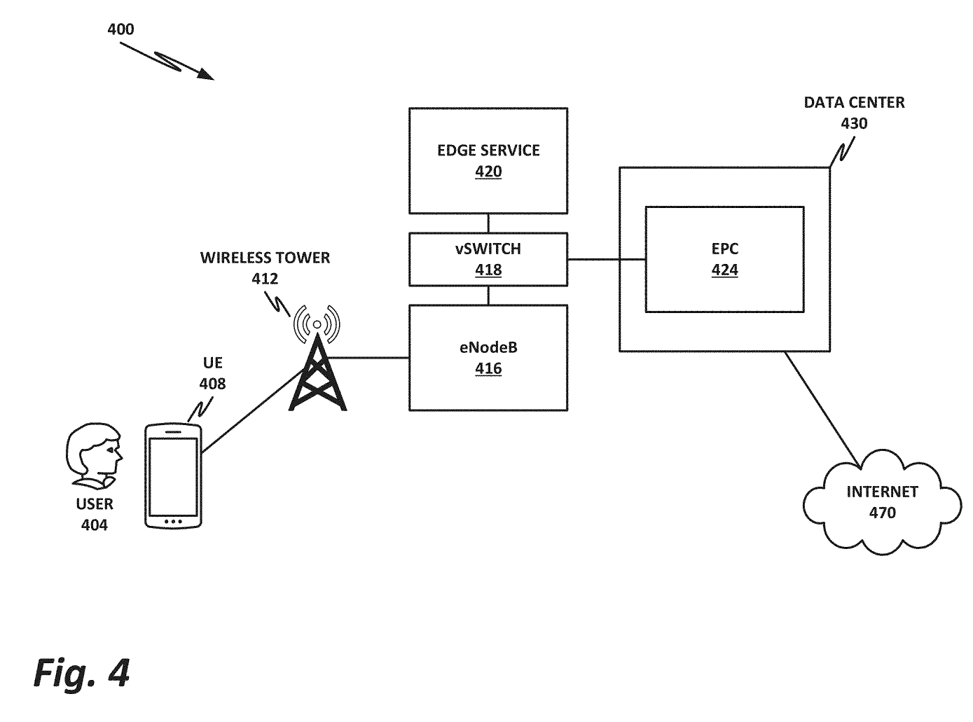

FIG. 4 is a block diagram of a wireless network 400 according to one or more examples of the present specification.

In the example of FIG. 4, a user 404 operating user equipment 408 communicates with wireless network 400. Specifically, user equipment 408 may be equipped with a wireless transceiver that can communicate with a wireless tower 412. Wireless tower 412 is then communicatively coupled to a base station, such as an eNodeB 416.

In the present embodiment, eNodeB 416 is an example of a base station used in a 4G LTE network. In other examples, other base stations may be used, such as a 3G NodeB, or a 5G or later base station. A vSwitch 418 services eNodeB 416, and may be configured to switch packets to an evolved packet core (EPC) 424. EPC 424 may be located in a data center 430, and may couple wireless network 400 to the Internet 470, or to any other network.

In this example, eNodeB 416 also includes an edge service 420. Edge service 420 provides a service or workload function that may be located at or near eNodeB 416, and which may provide a high bandwidth and/or low latency connection to user 404. For example, user 404 may be a premium subscriber to services of wireless network 400, and may be contractually provided with higher throughput. Edge service 420 could be by way of illustration a streaming video service, in which case it is advantageous to locate edge service 420 physically closer to eNodeB 416 (i.e., in terms of physical distance), and logically closer to eNodeB 416 (i.e., in terms of number of hops from eNodeB 416).

However, it should be noted that not all traffic provided by edge service 420 should be routed to edge service 420. For example, other nonpremium subscribers may be accessing wireless network 400, in which case their traffic may be routed to EPC 424, or out to Internet 470. Thus, when vSwitch 418 receives an incoming packet, the packet may take one of two paths. The packet may be directed to EPC 424 via an “inline” path, or may be “diverted” to edge service 420. The determination of whether to direct the incoming packet inline to EPC 424 or to divert the packet to edge service 400 may depend on a number of factors, including properties of the packet itself, such as subscriber information, or other information such as the loading on various network elements.

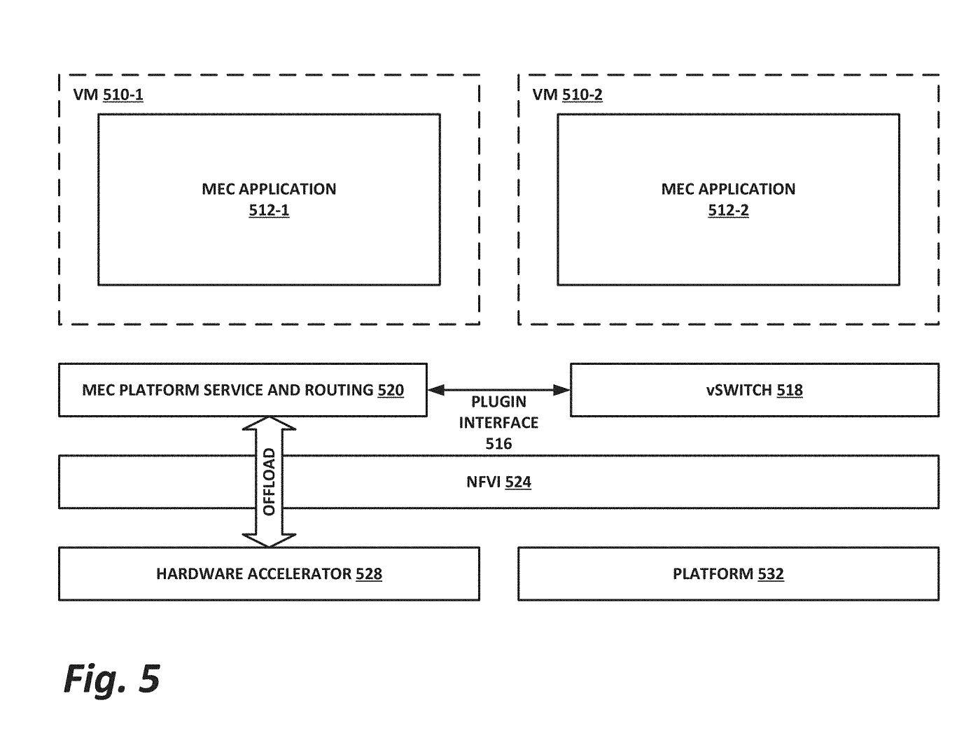

FIG. 5 is a block diagram of selected elements of the virtual network infrastructure according to one or more examples of the present specification.

In this example, a vSwitch 518 is provided with a plug-in interface 516, which allows the native functionality of vSwitch 518 to be extended to provide, for example, a VNF function which, in some examples, may determine whether to divert or inline traffic.

MEC is used in this example as an illustration of one function that may be incorporated into vSwitch 518. However this should be understood as a nonlimiting example, and other examples of plug-in VNFs may be provided in other embodiments.

In this case, an MEC platform service 520 traffic overload function may be incorporated into vSwitch 518 and one core function of vSwitch 518 may be to forward packets from a network interface port to various virtual machines.

In this example, VM 510-1 includes MEC application instance 512-1. VM 510-2 includes an MEC application instance 512-2.

Traffic may be routed by vSwitch 518 to either VM 510, which may represent a diversion path, or may route traffic inline to a non-diverted path. vSwitch 518 is a component of an NFV infrastructure (NFVI). This includes the resources used to host and connect the NFVs in a network function virtualization ecosystem. The vSwitch 518 is also hosted on a platform 532.

In this example, when traffic comes into vSwitch 518, vSwitch 518 may inspect the packet to determine whether it is an MEC candidate. This may include, for example, inspecting the GPRS Tunneling Protocol (GTP) tunneling endpoint ID (TEID) field, and/or the GTP-PDU application IP tuple, i.e., IP address or Internet assigned numbers authority (IANA) port number. Note that not all traffic of the type supported by MEC application 512-2 need necessarily be diverted to MEC application 512-2. In the previous figure, an example is shown wherein a premium subscriber's traffic is diverted to MEC application 512-2, but a nonpremium subscriber's traffic may be sent inline to the data center.

The provision of MEC platform service and routing 520 may be relatively compute and memory intensive. This may include high memory and I/O bandwidth requirements, which consumes a large number of CPU cycles from platform 532. However, this consumption of processor power can be reduced if vSwitch 518 uses MEC platform service and routing 520 to inspect incoming packets.

In this example, incoming packets may be passed via plug-in interface 516 to MEC platform service and routing function 520. MEC platform service and routing function 520 may offload the inspection to a hardware accelerator 528. Hardware accelerator 528 may perform the actual inspection of the packet, and may then either route the packet to an MEC application 512, via a diverted route, or may forward the packet via the inline route to the data center.

Note that ordinarily, a switch would have the capability to forward packets at either layer 2 or layer 3. In this example, vSwitch 518 is able to modify the packet to remove the GPRS Tunneling Protocol (GTP) header and forward the inner GTP-PDU application IP packet using layer 3 forwarding. This saves transactions in the network.

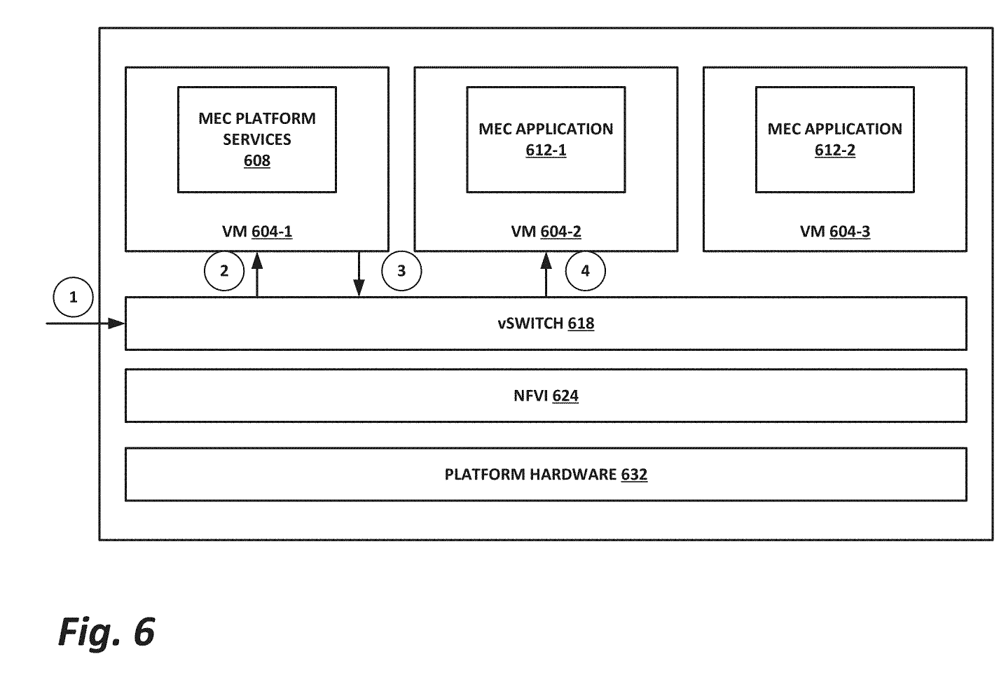

FIG. 6 is a block diagram of a virtual network infrastructure according to one or more examples of the present specification. This figure illustrates network transactions that may be necessary in the absence of an integrated MEC function within vSwitch 518.

In this example, a vSwitch 618 is provided. The vSwitch 618 does not have an integrated MEC capability. Thus, MEC platform services 608 are provided by VM 604-1. As before, two MEC application instances 612 are provided by VM 604-2 and VM 604-3.

As before, vSwitch 618 is serviced by NFVI 624 and platform hardware 632.

In this example, at operation 1, vSwitch 618 receives a GTP packet from a network interface port connected to the eNodeB. The vSwitch 618 inspects the packet using standard IP tuple and routes the packet to VM 604-1 hosting MEC platform services 608.

At operation 2, MEC platform services 608 receives the GTP packet and inspects it using the MEC lookup rules (such as GTP TEID, and interapplication IP tuple) and performs GTP decapsulation if necessary. MEC platform services function 608 then sends the packet back to vSwitch 618.

In operation 3, vSwitch 618 receives the packet, and may now know that it is to be diverted to MEC application 612-1. Thus, at operation 4, vSwitch 618 diverts the packet to VM 604-2 hosting MEC application instance 612-1.

Note that the MEC platform services function 608 is computationally intense, and may require significant resources of platform hardware 632. Thus, additional latency is added by operations 2 and 3 of FIG. 6.

However, embodiments of the present specification may reduce latency by streamlining certain transactions.

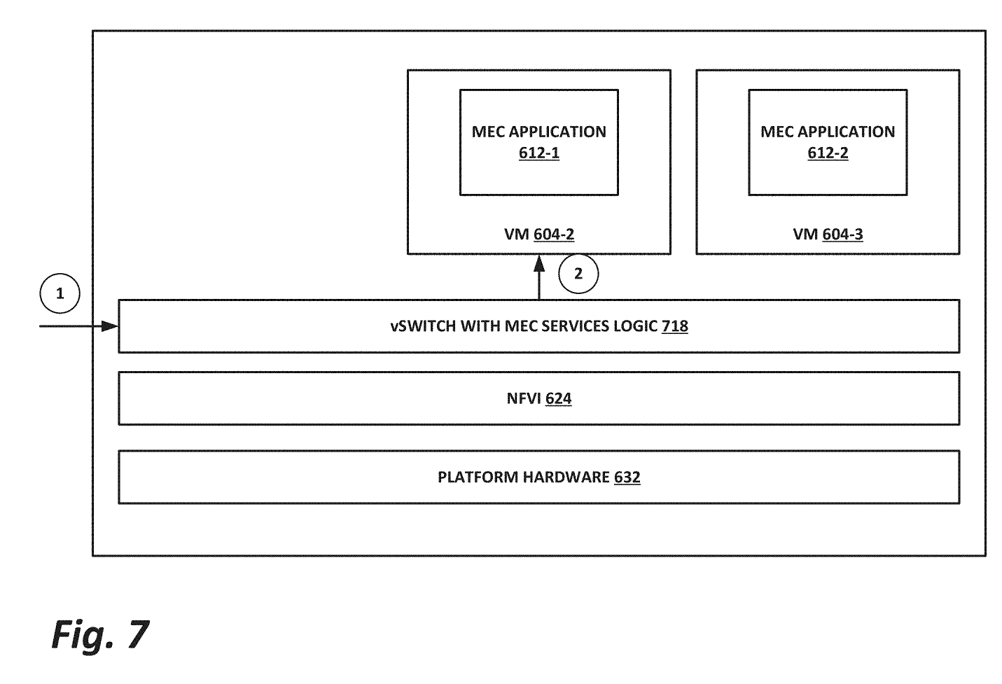

FIG. 7 illustrates an instance of streamlining wherein vSwitch 618 has been replaced with vSwitch 718, which includes MEC services logic, according to one or more examples of the present specification. Note that in this case, VM 604-1 hosting MEC platform services 608 is unnecessary. Rather, at operation 1, an inbound packet hits vSwitch 718. As illustrated in FIG. 5, vSwitch 718 may include MEC platform services, and may offload processing of the MEC inspection to either dedicated software, or in some embodiments to a hardware accelerator. Thus, VM 604-1 is not consuming platform hardware resources 632, and in many cases, the dedicated MEC platform logic may be faster than MEC platform services 608 running on a virtual machine as in FIG. 6.

Because the embodiment of FIG. 7 eliminates the MEC platform traffic offload to VM 604-1, there are improvements in performance and operating costs. In this example, vSwitch 718 is provided with additional functionality including:

a. Detecting UE flows (GTP TEID) and inter-application IP tuple.

b. Performing GTP decapsulation if needed.

c. Routing the packet to the appropriate VM, in this case VM 604-2.

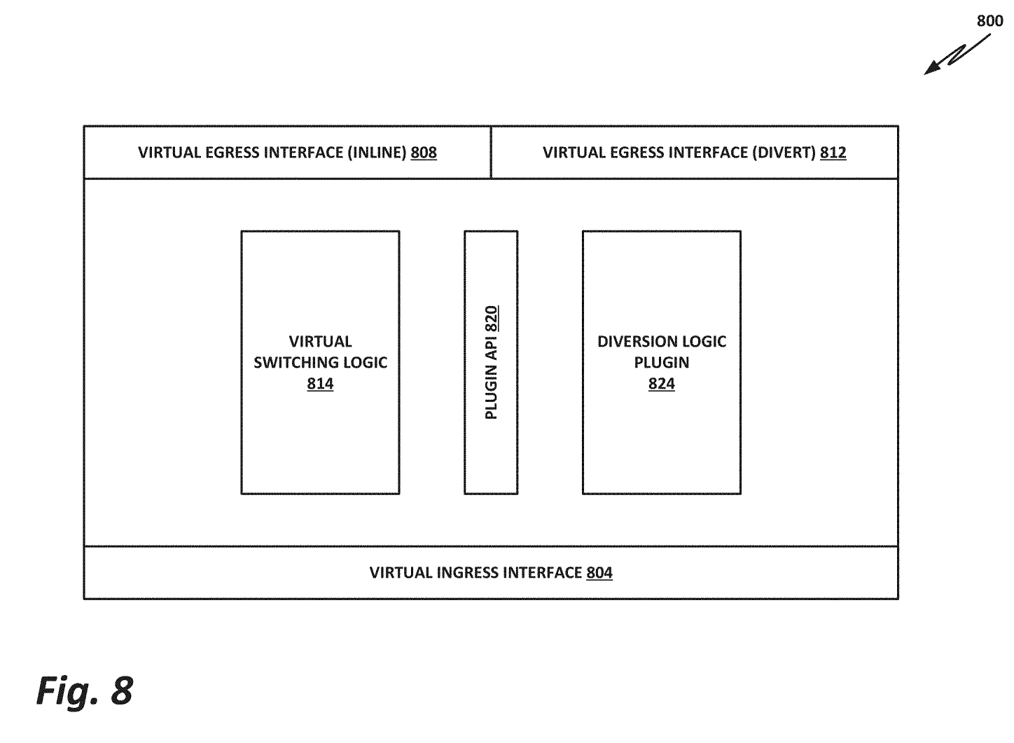

FIG. 8 is a block diagram of a vSwitch 800 according to one or more examples of the present specification.

In this example, vSwitch 800 includes a virtual ingress interface 804, an inline virtual ingress interface 808, and a diverted virtual egress interface 812. Note that the virtual ingress and egress interfaces may be of the shared memory type, in which virtual switch 800 switches traffic by writing to or reading from shared memory locations. According to its ordinary function, vSwitch 800 would receive packets on virtual ingress interface 804, operate virtual switching logic 814 to switch the packets, and direct the packets to one or more inline virtual egress interfaces 808.

However, in this case, vSwitch 800 also includes a plug-in API 820, and a diversion logic plug-in 824. Thus, when incoming packets hit virtual ingress interface 804, and are provided to virtual switching logic 814, either all packets or all packets of a certain class are handed off to plug-in API 820. Plug-in API 820 then provides the packets to diversion logic plug-in 824. Diversion logic plug-in 824 may be provided in software, firmware, hardware, or any combination of the foregoing. In one particular instance, diversion logic plug-in 824 may be provided by a hardware accelerator in an FPGA for an ASIC. Ultimately, diversion logic plug-in 824 determines whether to switch traffic via inline virtual egress interface 808 or diverted virtual egress interface 812. For example, diverted virtual egress interface 812 may switch packets to a local resource instance, whereas inline virtual egress interface 808 may switch packets out to a downstream data center.

When virtual ingress interface 804 receives an incoming packet, virtual switching logic 814 may perform its normal L2 or L3 switching with the extra action, such as MEC being added. If a particular flow has MEC routing as an action (or in other words, if a particular flow belongs to a class of traffic that should be inspected by diversion logic plug-in 824) the packet is provided to diversion logic plug-in 824 via plug-in API 820.

When diversion logic plug-in 824 receives packets, it identifies the appropriate flow, such as an MEC flow based on the GTP TEID field and/or the GTP-PDU application IP tuple (i.e., IP address or IANA port number). The rule that is used may depend on the MEC application in the target VM.

Once diversion logic plug-in 824 has completed its inspection, it will direct the flow to either inline virtual egress interface 808, or diverted virtual egress interface 812.

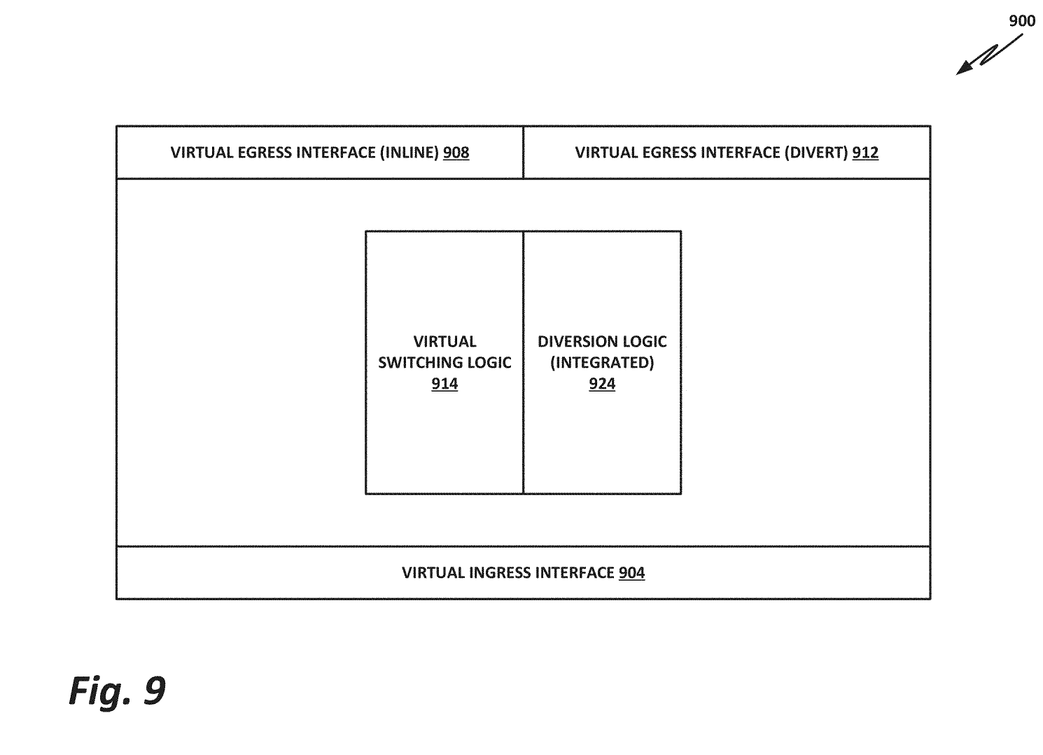

FIG. 9 is a block diagram of a vSwitch 900 according to one or more examples of the present specification.

In the example of FIG. 9, vSwitch 900 includes a virtual ingress interface 904, an inline virtual egress interface 908, and a diverted virtual egress interface 912. These perform functions similar to items 804, 808, and 812 of FIG. 8, respectively.

Similarly, virtual switching logic 914 performs a function similar to virtual switching logic 814 of FIG. 8, and diversion logic 924 performs a function similar to diversion logic 824 of FIG. 8. However, in this case, diversion logic 924 is natively integrated with virtual switching logic 914. As discussed above, this represents a trade-off between flexibility and efficiency. While integrated diversion logic 924 may be tightly coupled to virtual switching logic 914, and thus may be somewhat faster than diversion logic 824, which interfaces via a plug-in API 820, vSwitch 900 may lack some of the flexibility of vSwitch 800 of FIG. 8. Specifically, if vSwitch 900 is not provided with a plug-in API, then it may not be as extensible as vSwitch 800 of FIG. 8. The determination of whether to use an integrated diversion logic or a plug-in diversion logic is an exercise of ordinary skill that will depend on the demands of a particular embodiment.

The vSwitches described herein, such as vSwitch 800 of FIG. 8 and vSwitch 900 of FIG. 9 realize substantial advantages. These vSwitches enhance the flexibility of the vSwitching domain, and particularly in the case of vSwitch 800 with a plug-in API 820, open up a generic framework for adding additional plug-ins as described above. Also in the case of vSwitch 800 with plug-in API 820, a variety of hardware accelerators realized in FPGAs or ASICs may be used in place of software to further accelerate the function. Note that in some cases, even in the absence of a plug-in API, vSwitch 900 may provide integrated diversion logic 924 in hardware as well. This simply requires tighter coupling of the hardware to virtual switching logic 914 at design time.

Also as discussed above, this solution is modular and may provide enhanced switching on demand. Specifically, only flows of a certain class may be designated as needing inspection by diversion logic. Thus, flows not of that class, such as those lacking the specified GTP header, may simply be switched by way of virtual switching logic according to its ordinary function. Only those flows with the designated attributes are provided to the diversion logic for extra processing.

In experimental implementations, substantial speedups were realized compared to a baseline configuration in which diversion logic was provided in a separate virtual machine. In one experimental example, the MEC inspection within the vSwitch took on the order of 60 μs, whereas routing the packet through a VM performing MEC platform services took on the order of hundreds to thousands of ps, thus realizing at least an order of magnitude of savings in overhead.

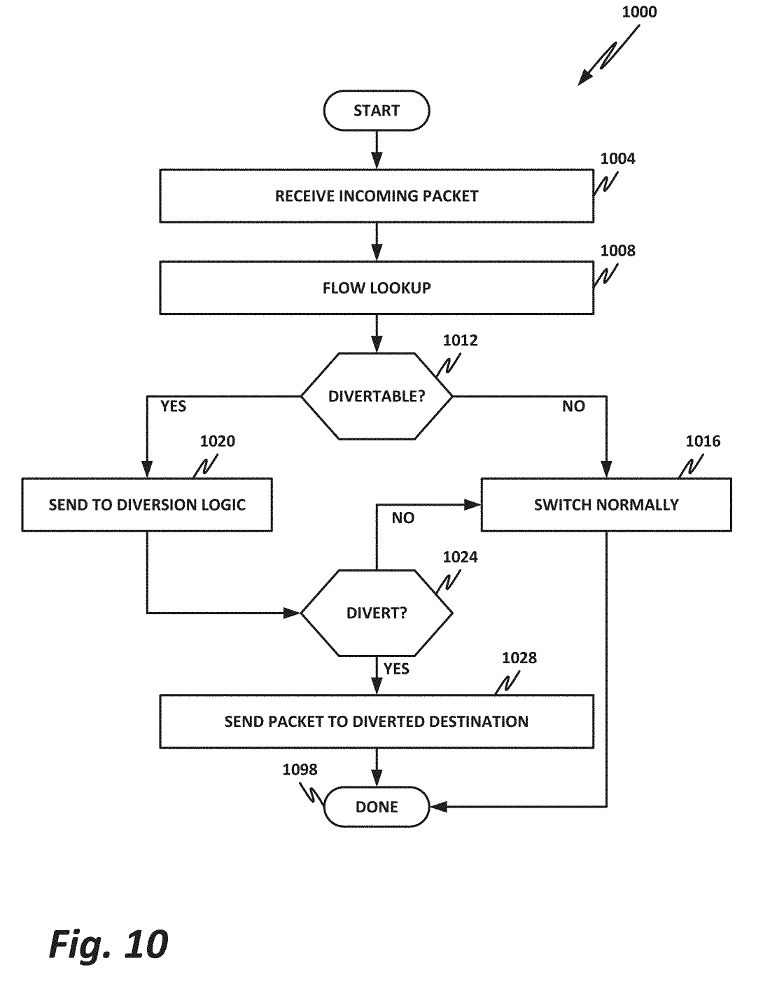

FIG. 10 is a flowchart of a method 1000 of performing enhanced NFV switching according to one or more examples of the present specification.

In block 1004, the vSwitch receives an incoming packet.

In block 1008, the vSwitch performs a flow look-up in a flow table for the incoming packet. This may determine whether the packet is of a “divertible” class or not. A divertible class includes packets that are candidates for diversion, such as to a local instance of a network function or workload service, versus inline routing to a data center. Note that diversion to a local instance is a nonlimiting example, and in other embodiments, diversion can be to any path other than the ordinary inline path for traffic.

In decision block 1012, the vSwitch determines whether this packet or flow is of a divertible class. If the packet is not divertible, then in block 1016, the packet is switched normally, and in block 1098, the method is done.

On the other hand, if the packet is determined to be of a divertible class in block 1012, then in block 1020, the packet is sent to diversion logic, as illustrated in FIG. 5. This may include a dedicated software function on the vSwitch, or it may include hardware acceleration as appropriate to the embodiment. Ultimately, the purpose of block 1020 is to determine whether the packet should in fact be diverted.

In decision block 1024, if the packet is not to be diverted, then again in block 1016, the packet is switched normally to the inline path, and in block 1098, the method is done.

Returning to block 1024, if the packet is to be diverted, then in block 1028, the packet is sent to the diverted destination, such as a local instance of a function, or any other diverted path.

In block 1098, the method is done.

The foregoing outlines features of several embodiments so that those skilled in the art may better understand various aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

All or part of any hardware element disclosed herein may readily be provided in a system-on-a-chip (SoC), including central processing unit (CPU) package. An SoC represents an integrated circuit (IC) that integrates components of a computer or other electronic system into a single chip. Thus, for example, client devices or server devices may be provided, in whole or in part, in an SoC. The SoC may contain digital, analog, mixed-signal, and radio frequency functions, all of which may be provided on a single chip substrate. Other embodiments may include a multichip module (MCM), with a plurality of chips located within a single electronic package and configured to interact closely with each other through the electronic package.

Note also that in certain embodiments, some of the components may be omitted or consolidated. In a general sense, the arrangements depicted in the figures may be more logical in their representations, whereas a physical architecture may include various permutations, combinations, and/or hybrids of these elements. It is imperative to note that countless possible design configurations can be used to achieve the operational objectives outlined herein. Accordingly, the associated infrastructure has a myriad of substitute arrangements, design choices, device possibilities, hardware configurations, software implementations, and equipment options.

In a general sense, any suitably-configured processor can execute any type of instructions associated with the data to achieve the operations detailed herein. Any processor disclosed herein could transform an element or an article (for example, data) from one state or thing to another state or thing. In operation, a storage may store information in any suitable type of tangible, nontransitory storage medium (for example, random access memory (RAM), read only memory (ROM), field programmable gate array (FPGA), erasable programmable read only memory (EPROM), electrically erasable programmable ROM (EEPROM), etc.), software, hardware (for example, processor instructions or microcode), or in any other suitable component, device, element, or object where appropriate and based on particular needs. Furthermore, the information being tracked, sent, received, or stored in a processor could be provided in any database, register, table, cache, queue, control list, or storage structure, based on particular needs and implementations, all of which could be referenced in any suitable timeframe. Any of the memory or storage elements disclosed herein, should be construed as being encompassed within the broad terms ‘memory’ and ‘storage,’ as appropriate. A nontransitory storage medium herein is expressly intended to include any nontransitory special-purpose or programmable hardware configured to provide the disclosed operations, or to cause a processor to perform the disclosed operations.

Computer program logic implementing all or part of the functionality described herein is embodied in various forms, including, but in no way limited to, a source code form, a computer executable form, machine instructions or microcode, programmable hardware, and various intermediate forms (for example, forms generated by an assembler, compiler, linker, or locator). In an example, source code includes a series of computer program instructions implemented in various programming languages, such as an object code, an assembly language, or a high-level language such as OpenCL, FORTRAN, C, C++, JAVA, or HTML for use with various operating systems or operating environments, or in hardware description languages such as Spice, Verilog, and VHDL. The source code may define and use various data structures and communication messages. The source code may be in a computer executable form (e.g., via an interpreter), or the source code may be converted (e.g., via a translator, assembler, or compiler) into a computer executable form, or converted to an intermediate form such as byte code. Where appropriate, any of the foregoing may be used to build or describe appropriate discrete or integrated circuits, whether sequential, combinatorial, state machines, or otherwise.

In one example embodiment, any number of electrical circuits of the FIGURES may be implemented on a board of an associated electronic device. The board can be a general circuit board that can hold various components of the internal electronic system of the electronic device and, further, provide connectors for other peripherals. Any suitable processor and memory can be suitably coupled to the board based on particular configuration needs, processing demands, and computing designs.

Note that with the numerous examples provided herein, interaction may be described in terms of two, three, four, or more electrical components. However, this has been done for purposes of clarity and example only. It should be appreciated that the system can be consolidated or reconfigured in any suitable manner. Along similar design alternatives, any of the illustrated components, modules, and elements of the FIGURES may be combined in various possible configurations, all of which are within the broad scope of this specification.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 (pre-AIA) or paragraph (f) of the same section (post-AIA), as it exists on the date of the filing hereof unless the words “means for” or “steps for” are specifically used in the particular claims; and (b) does not intend, by any statement in the specification, to limit this disclosure in any way that is not otherwise expressly reflected in the appended claims.

### EXAMPLE IMPLEMENTATIONS

The following examples are provided by way of illustration.

Example 1 includes a computing apparatus, comprising: a hardware platform; and a virtual switch (vSwitch) to operate on the hardware platform, the vSwitch comprising a virtual ingress interface, an inline virtual egress interface to communicatively couple to an inline data path, a diverted virtual egress interface to communicatively couple to a diverted data path, a diversion logic block, and logic to: communicatively couple to a local virtual machine (VM) via the diverted data path, the VM to provide an edge computing function; communicatively couple to a downstream data center via the inline data path; receive an incoming packet via the virtual ingress interface; determine that the incoming packet belongs to a class of packets for diversion processing; provide the incoming packet to the diversion logic block, wherein the diversion logic block is to determine that the packet is an edge computing flow to be diverted to the edge computing function via the diverted data path; and direct the incoming packet to the local VM via the diverted virtual egress interface.

Example 2 includes the computing apparatus of example 1, wherein the edge computing function is multi-access edge computing (MEC).

Example 3 includes the computing apparatus of example 1, wherein the diversion logic block is further to determine that the packet is not to be diverted to the diverted data path, and to direct the incoming packet to the inline virtual egress interface.

Example 4 includes the computing apparatus of example 1, wherein the diversion logic block interfaces with the vSwitch via a plug-in architecture.

Example 5 includes the computing apparatus of example 1, wherein the diversion logic block is integrated into the vSwitch.

Example 6 includes the computing apparatus of example 1, wherein determining that the packet is to be diverted to the diverted data path comprises looking up an attribute of the packet in a rules table.

Example 7 includes the computing apparatus of example 6, wherein looking up the attribute of the packet in the rules table comprises determining that the packet is for an end user having a premium subscription.

Example 8 includes the computing apparatus of any of examples 1-7, wherein the diversion logic block comprises a software block.

Example 9 includes the computing apparatus of any of examples 1-7, wherein the diversion logic block comprises a hardware accelerator.

Example 10 includes one or more tangible, non-transitory computer-readable mediums having stored thereon instructions for providing a virtual switch comprising a diversion logic block, the instructions to: communicatively couple to a virtual ingress interface; communicatively couple to an inline virtual egress interface to communicatively couple to an inline data path; communicatively couple to a diverted virtual egress interface to communicatively couple to a diverted data path; communicatively couple to a local virtual machine (VM) via the diverted data path, the VM to provide an edge computing function; communicatively couple to a downstream data center via the inline data path; receive an incoming packet via the virtual ingress interface; determine that the incoming packet belongs to a class of packets for diversion processing; provide the incoming packet to the diversion logic block, wherein the diversion logic block is to determine that the packet is an edge computing flow to be diverted to the edge computing function via the diverted data path; and direct the incoming packet to the local VM via the diverted virtual egress interface.

Example 11 includes the one or more tangible, non-transitory computer-readable mediums of example 10, wherein the edge computing function is multi-access edge computing (MEC).

Example 12 includes the one or more tangible, non-transitory computer-readable mediums of example 10, wherein the diversion logic block is further to determine that the packet is not to be diverted to the diverted data path, and to direct the incoming packet to the inline virtual egress interface.

Example 13 includes the one or more tangible, non-transitory computer-readable mediums of example 10, wherein the diversion logic block interfaces with the vSwitch via a plug-in architecture.

Example 14 includes the one or more tangible, non-transitory computer-readable mediums of example 10, wherein the diversion logic block is integrated into the vSwitch.

Example 15 includes the one or more tangible, non-transitory computer-readable mediums of example 10, wherein determining that the packet is to be diverted to the diverted data path comprises looking up an attribute of the packet in a rules table.

Example 16 includes the one or more tangible, non-transitory computer-readable mediums of example 15, wherein looking up the attribute of the packet in the rules table comprises determining that the packet is for an end user having a premium subscription.

Example 17 includes the one or more tangible, non-transitory computer-readable mediums of any of examples 10-16, wherein the diversion logic block comprises a software block.

Example 18 includes the one or more tangible, non-transitory computer-readable mediums of any of examples 10-16, wherein the diversion logic block is configured to operate with a hardware accelerator.

Example 19 includes a computer-implemented method of providing a virtual switch comprising a diversion logic block, comprising: communicatively coupling to a virtual ingress interface; communicatively coupling to an inline virtual egress interface to communicatively couple to an inline data path; communicatively coupling a diverted virtual egress interface to communicatively couple to a diverted data path; communicatively coupling to a local virtual machine (VM) via the diverted data path, the VM to provide an edge computing function; communicatively coupling to a downstream data center via the inline data path; receiving an incoming packet via the virtual ingress interface; determining that the incoming packet belongs to a class of packets for diversion processing; providing the incoming packet to the diversion logic block, wherein the diversion logic block is to determine that the packet is an edge computing flow to be diverted to the edge computing function via the diverted data path; and directing the incoming packet to the local VM via the diverted virtual egress interface.

Example 20 includes the method of example 19, wherein the edge computing function is multi-access edge computing (MEC).

Example 21 includes the method of example 19, wherein the diversion logic block is further to determine that the packet is not to be diverted to the diverted data path, and to direct the incoming packet to the inline virtual egress interface.

Example 22 includes the method of example 19, wherein the diversion logic block interfaces with the vSwitch via a plug-in architecture.

Example 23 includes the method of example 19, wherein the diversion logic block is integrated into the vSwitch.

Example 24 includes the method of example 19, wherein determining that the packet is to be diverted to the diverted data path comprises looking up an attribute of the packet in a rules table.

Example 25 includes the method of example 24, wherein looking up the attribute of the packet in the rules table comprises determining that the packet is for an end user having a premium subscription.

Example 26 includes the method of any of examples 19-25, wherein the diversion logic block comprises a software block.

Example 27 includes the method of any of examples 19-25, wherein the diversion logic block is configured to operate with a hardware accelerator.

Example 28 includes an apparatus comprising means for performing the method of any of examples 19-27.

Example 29 includes the apparatus of example 28, wherein the means for performing the method comprise a processor and a memory.

Example 30 includes the apparatus of example 29, wherein the memory comprises machine-readable instructions, that when executed cause the apparatus to perform the method of any of examples 19-27.

Example 31 includes the apparatus of any of examples 28-30, wherein the apparatus is a computing system.

Example 32 includes at least one computer readable medium comprising instructions that, when executed, implement a method or realize an apparatus as illustrated in any of examples 19-31.

Example 33 includes a computing apparatus, comprising: a hardware platform; and a virtual switch (vSwitch) to operate on the hardware platform, the vSwitch comprising a virtual ingress interface, an inline virtual egress interface to communicatively couple to an inline data path, a diverted virtual egress interface to communicatively couple to a diverted data path, a plug-in application programming interface (API), and logic to: communicatively couple to the diverted data path via the diverted virtual egress interface; communicatively couple to the inline data path via the inline virtual ingress interface; and communicatively couple to a diversion logic plug-in via the plug-in API, the diversion logic plug-in to, for a packet class, select between the inline virtual egress interface and the diverted virtual egress interface.

Example 34 includes the computing apparatus of example 33, wherein the diversion logic plug-in is an edge computing plug-in, and the logic is to: receive an incoming packet via the virtual ingress interface; determine that the incoming packet belongs to a class of packets for diversion processing; provide the incoming packet to the diversion logic block, wherein the diversion logic block is to determine that the packet is an edge computing flow to be diverted to the edge computing function via the diverted data path; and direct the incoming packet to the diverted virtual egress interface.

Example 35 includes the computing apparatus of example 34, wherein the edge computing function is multi-access edge computing (MEC).

Example 36 includes the computing apparatus of example 34, wherein the diversion logic block is further to determine that the packet is not to be diverted to the diverted data path, and to direct the incoming packet to the inline virtual egress interface.

Example 37 includes the computing apparatus of example 34, wherein determining that the packet is to be diverted to the diverted data path comprises looking up an attribute of the packet in a rules table.

Example 38 includes the computing apparatus of example 37, wherein looking up the attribute of the packet in the rules table comprises determining that the packet is for an end user having a premium subscription.

Example 39 includes the computing apparatus of any of examples 33-37, wherein the diversion logic block comprises a software block.

Example 40 includes the computing apparatus of any of examples 33-37, wherein the diversion logic block comprises a hardware accelerator.

Example 41 includes the computing apparatus of any of examples 33-37, wherein the diversion logic block is selected from a group consisting of IP security (IPSec), deep packet inspection (DPI), cryptography, and a logging function.

Example 42 includes one or more tangible, non-transitory computer-readable mediums having stored thereon executable instructions for providing a virtual switch, the instructions to: provision a virtual ingress interface; provision an inline virtual egress interface to communicatively couple to an inline data path; provision a diverted virtual egress interface to communicatively couple to a diverted data path; provision a plug-in application programming interface (API); communicatively couple to the diverted data path via the diverted virtual egress interface; communicatively couple to the inline data path via the inline virtual ingress interface; and communicatively couple to a diversion logic plug-in via the plug-in API, the diversion logic plug-in to, for a packet class, select between the inline virtual egress interface and the diverted virtual egress interface.

Example 43 includes the one or more tangible, non-transitory computer-readable mediums of example 42, wherein the diversion logic plug-in is an edge computing plug-in, and the instructions are further to: receive an incoming packet via the virtual ingress interface; determine that the incoming packet belongs to a class of packets for diversion processing; provide the incoming packet to the diversion logic block, wherein the diversion logic block is to determine that the packet is an edge computing flow to be diverted to the edge computing function via the diverted data path; and direct the incoming packet to the diverted virtual egress interface.

Example 44 includes the one or more tangible, non-transitory computer-readable mediums of example 43, wherein the edge computing function is multi-access edge computing (MEC).

Example 45 includes the one or more tangible, non-transitory computer-readable mediums of example 44, wherein the diversion logic block is further to determine that the packet is not to be diverted to the diverted data path, and to direct the incoming packet to the inline virtual egress interface.

Example 46 includes the one or more tangible, non-transitory computer-readable mediums of example 44, wherein determining that the packet is to be diverted to the diverted data path comprises looking up an attribute of the packet in a rules table.

Example 47 includes the one or more tangible, non-transitory computer-readable mediums of example 46, wherein looking up the attribute of the packet in the rules table comprises determining that the packet is for an end user having a premium subscription.

Example 48 includes the one or more tangible, non-transitory computer-readable mediums of any of examples 42-47, wherein the diversion logic block comprises a software block.

Example 49 includes the one or more tangible, non-transitory computer-readable mediums of any of examples 42-47, wherein the diversion logic block comprises a hardware accelerator.

Example 50 includes the one or more tangible, non-transitory computer-readable mediums of any of examples 42-47, wherein the diversion logic block is selected from a group consisting of IP security (IPSec), deep packet inspection (DPI), cryptography, and a logging function.

Example 51 includes a computer-implemented method for providing a virtual switch, the instructions to: provision a virtual ingress interface; provision an inline virtual egress interface to communicatively couple to an inline data path; provision a diverted virtual egress interface to communicatively couple to a diverted data path; provision a plug-in application programming interface (API); communicatively couple to the diverted data path via the diverted virtual egress interface; communicatively couple to the inline data path via the inline virtual ingress interface; and communicatively couple to a diversion logic plug-in via the plug-in API, the diversion logic plug-in to, for a packet class, select between the inline virtual egress interface and the diverted virtual egress interface.

Example 52 includes The method of example 51, wherein the diversion logic plug-in is an edge computing plug-in, and the instructions are further to: receive an incoming packet via the virtual ingress interface; determine that the incoming packet belongs to a class of packets for diversion processing; provide the incoming packet to the diversion logic block, wherein the diversion logic block is to determine that the packet is an edge computing flow to be diverted to the edge computing function via the diverted data path; and direct the incoming packet to the diverted virtual egress interface.

Example 53 includes the method of example 52, wherein the edge computing function is multi-access edge computing (MEC).

Example 54 includes the method of example 53, wherein the diversion logic block is further to determine that the packet is not to be diverted to the diverted data path, and to direct the incoming packet to the inline virtual egress interface.

Example 55 includes the method of example 53, wherein determining that the packet is to be diverted to the diverted data path comprises looking up an attribute of the packet in a rules table.

Example 56 includes the method of example 55, wherein looking up the attribute of the packet in the rules table comprises determining that the packet is for an end user having a premium subscription.

Example 57 includes the method of any of examples 51-56, wherein the diversion logic block comprises a software block.

Example 58 includes the method of any of examples 51-56, wherein the diversion logic block comprises a hardware accelerator.

Example 59 includes the method of any of examples 51-56, wherein the diversion logic block is selected from a group consisting of IP security (IPSec), deep packet inspection (DPI), cryptography, and a logging function.

Example 60 includes an apparatus comprising means for performing the method of any of examples 51-59.

Example 61 includes the apparatus of example 60, wherein the means for performing the method comprise a processor and a memory.

Example 62 includes the apparatus of example 61, wherein the memory comprises machine-readable instructions, that when executed cause the apparatus to perform the method of any of examples 51-59.

Example 63 includes the apparatus of any of examples 60-62, wherein the apparatus is a computing system.

Example 64 includes at least one computer readable medium comprising instructions that, when executed, implement a method or realize an apparatus as illustrated in any of examples 51-63.

What is claimed is:

1. A computing apparatus, comprising:
a hardware platform; and
a virtual switch (vSwitch) to operate on the hardware platform, the vSwitch comprising a virtual ingress interface, an inline virtual egress interface to communicatively couple to an inline data path, a diverted virtual egress interface to communicatively couple to a diverted data path, a diversion logic block, and logic to:
communicatively couple to a local virtual machine (VM) via the diverted data path, the VM to provide an edge computing function;
communicatively couple to a downstream data center via the inline data path;
receive an incoming packet via the virtual ingress interface;
determine that the incoming packet belongs to a class of packets for diversion processing;
provide the incoming packet to the diversion logic block, wherein the diversion logic block is to determine that the packet is an edge computing flow to be diverted to the edge computing function via the diverted data path; and
direct the incoming packet to the local VM via the diverted virtual egress interface.

2. The computing apparatus of claim 1, wherein the edge computing function is multi-access edge computing (MEC).

3. The computing apparatus of claim 1, wherein the diversion logic block is further to determine that the packet is not to be diverted to the diverted data path, and to direct the incoming packet to the inline virtual egress interface.

4. The computing apparatus of claim 1, wherein the diversion logic block interfaces with the vSwitch via a plug-in architecture.

5. The computing apparatus of claim 1, wherein the diversion logic block is integrated into the vSwitch.

6. The computing apparatus of claim 1, wherein determining that the packet is to be diverted to the diverted data path comprises looking up an attribute of the packet in a rules table.

7. The computing apparatus of claim 6, wherein looking up the attribute of the packet in the rules table comprises determining that the packet is for an end user having a premium subscription.

8. The computing apparatus of claim 1, wherein the diversion logic block comprises a software block.

9. The computing apparatus of claim 1, wherein the diversion logic block comprises a hardware accelerator.

10. One or more tangible, non-transitory computer-readable mediums having stored thereon instructions for providing a virtual switch comprising a diversion logic block, the instructions to:
communicatively couple to a virtual ingress interface;
communicatively couple to an inline virtual egress interface to communicatively couple to an inline data path;
communicatively couple to a diverted virtual egress interface to communicatively couple to a diverted data path;
communicatively couple to a local virtual machine (VM) via the diverted data path, the VM to provide an edge computing function;
communicatively couple to a downstream data center via the inline data path;
receive an incoming packet via the virtual ingress interface;
determine that the incoming packet belongs to a class of packets for diversion processing;
provide the incoming packet to the diversion logic block, wherein the diversion logic block is to determine that the packet is an edge computing flow to be diverted to the edge computing function via the diverted data path; and
direct the incoming packet to the local VM via the diverted virtual egress interface.

11. The one or more tangible, non-transitory computer-readable mediums of claim 10, wherein the edge computing function is multi-access edge computing (MEC).

12. The one or more tangible, non-transitory computer-readable mediums of claim 10, wherein the diversion logic block is further to determine that the packet is not to be diverted to the diverted data path, and to direct the incoming packet to the inline virtual egress interface.

13. The one or more tangible, non-transitory computer-readable mediums of claim 10, wherein the diversion logic block interfaces with the vSwitch via a plug-in architecture.

14. The one or more tangible, non-transitory computer-readable mediums of claim 10, wherein the diversion logic block is integrated into the vSwitch.

15. The one or more tangible, non-transitory computer-readable mediums of claim 10, wherein determining that the packet is to be diverted to the diverted data path comprises looking up an attribute of the packet in a rules table.

16. The one or more tangible, non-transitory computer-readable mediums of claim 15, wherein looking up the attribute of the packet in the rules table comprises determining that the packet is for an end user having a premium subscription.

17. The one or more tangible, non-transitory computer-readable mediums of claim 10, wherein the diversion logic block comprises a software block.

18. The one or more tangible, non-transitory computer-readable mediums of claim 10, wherein the diversion logic block is configured to operate with a hardware accelerator.

19. A computer-implemented method of providing a virtual switch comprising a diversion logic block, comprising:
communicatively coupling to a virtual ingress interface;
communicatively coupling to an inline virtual egress interface to communicatively couple to an inline data path;
communicatively coupling a diverted virtual egress interface to communicatively couple to a diverted data path;
communicatively coupling to a local virtual machine (VM) via the diverted data path, the VM to provide an edge computing function;
communicatively coupling to a downstream data center via the inline data path;
receiving an incoming packet via the virtual ingress interface;
determining that the incoming packet belongs to a class of packets for diversion processing;
providing the incoming packet to the diversion logic block, wherein the diversion logic block is to determine that the packet is an edge computing flow to be diverted to the edge computing function via the diverted data path; and
directing the incoming packet to the local VM via the diverted virtual egress interface.

20. The method of claim 19, wherein the edge computing function is multi-access edge computing (MEC).

21. The method of claim 19, wherein the diversion logic block is further to determine that the packet is not to be diverted to the diverted data path, and to direct the incoming packet to the inline virtual egress interface.

22. The method of claim 19, wherein the diversion logic block interfaces with the vSwitch via a plug-in architecture.

23. The method of claim 19, wherein the diversion logic block is integrated into the vSwitch.

24. The method of claim 19, wherein determining that the packet is to be diverted to the diverted data path comprises looking up an attribute of the packet in a rules table.

25. The method of claim 24, wherein looking up the attribute of the packet in the rules table comprises determining that the packet is for an end user having a premium subscription.
